(19) United States
(12) Patent Application Publication
(10) Pub. No.: US 2026/0312403 A1
(43) Pub. Date: Oct. 8, 2026

(54) POWER SUPPLY CONTROL SYSTEM, LOAD APPARATUS AND METHOD

(71) Applicant: SENAO NETWORKS, INC., TAOYUAN (TW)

(72) Inventor: Pi-Kuang KU, TAOYUAN (TW)

(21) Appl. No.: 19/330,982

(22) Filed: Sep. 17, 2025

(30) Foreign Application Priority Data
Apr. 2, 2025 (TW) 114112761

(51) Int. Cl. H02J 1/14; H02J 13/00; H02M 1/00

(52) U.S. Cl. CPC H02J 1/14; H02J 13/1311; H02M 1/0009

(57) ABSTRACT

A power supply control system, a load apparatus and a power supply control method are provided. In the power supply control system, a power supply apparatus supplies an initial voltage, and a load apparatus receives the initial voltage from a first node and transmits, via a second node, a feedback current signal having at least a first information feature generated by a first circuit module and a second information feature generated by a second circuit module. The power supply apparatus detects the first information feature to determine a first power supply parameter, detects the second information feature to determine a second power supply parameter, and supplies electric power based on the first and second power supply parameters. The first power supply parameter is one selected from voltage, current or wattage, and the second power supply parameter is another one selected from voltage, current or wattage of the feedback current signal.

### CROSS-REFERENCE TO RELATED APPLICATION

This application claims priority to Tiawan Patent Application No. 114112761 filed on Apr. 2, 2025, the contents of which are incorporated herein by reference in its entirety.

### FIELD OF INVENTION

The present invention relates generally to power electronics technology, and more particularly to a power supply control system and a load apparatus.

### BACKGROUND

Conventional long-distance power transmission generally uses fixed voltage or current methods. Since the specifications of the load apparatuses at the receiving end vary, the corresponding power supply apparatuses at the supply end are also diverse, which are inconvenient to use and subject to high risks of equipment damage. Therefore, alternative multi-voltage power supplies must install communication chips to both the power supply apparatus and the load apparatus for communication, wherein the load apparatus will send a message to the power supply apparatus to inform the appropriate power supply parameters such as voltage or wattage, and the power supply apparatus will then supply power according to the power supply parameters. In addition, dedicated signal transmission lines are required for communication chips, which are generally unfavorable to use in industrial equipment.

### SUMMARY

One objective of the present invention is to introduce a feedback current signal mechanism of a load apparatus at the receiving end, enable the power supply apparatus to instantly determine or adjust the power supply parameters, and improve power supply efficiency and startup speed of the power supply apparatus.

Another objective of the present invention is to introduce the feedback current signal mechanism of the load apparatus at the receiving end, enable the power supply apparatus to correctly determine or adjust the power supply parameters through a pair of power transmission lines without adding communication chips and signal transmission lines, reduce the development, operation and maintenance costs of load apparatuses with varying specifications, and improve stability and reliability.

One aspect of the present invention may be related to a power supply control system comprising a power supply apparatus and a load apparatus. The power supply apparatus may supply an initial voltage, and the load apparatus may receive the initial voltage and transmit a feedback current signal to the power supply apparatus in response to the initial voltage. The feedback current signal may have at least a first information feature and a second information feature. The power supply apparatus may be configured to: detect the first information feature to determine a first power supply parameter; detect the second information feature to determine a second power supply parameter; and supply electric power to the load apparatus based on the first power supply parameter and the second power supply parameter, wherein the first power supply parameter is one selected from voltage, current or wattage of the feedback current signal, and the second power supply parameter is another one selected from the voltage, the current or the wattage of the feedback current signal different from the first power supply parameter.

In some implementations, the load apparatus may comprise a load resistor, a switching element, a voltage stabilizing element, a control resistor and a control capacitor. A first terminal of the load resistor may be coupled to a first node. A first terminal of the switching element may be coupled to a second terminal of the load resistor, a second terminal of the switching element may be coupled to a first terminal of the control resistor at a second node, a control terminal of the switching element may be coupled to a second terminal of the control resistor. The voltage stabilizing element may be coupled to the first node and may be configured to be turned off in response to a voltage level of the first node being lower than a critical voltage level, and be turned on in response to the voltage level of the first node being higher than or equal to the critical voltage level. The control capacitor may be coupled between the voltage stabilizing element and the control terminal of the switching element. The power supply apparatus may supply the initial voltage to the first node and receive the feedback current signal from the second node. The initial voltage may be higher than or equal to the sum of the critical voltage level and an enabling voltage level of the switching element.

In some implementations, the first information feature may be a current level, and the second information feature may be the time duration before the current level returns to zero.

In some implementations, the load apparatus may comprise a first load resistor, a first switching element, a first voltage stabilizing element, a first control resistor, a first control capacitor, a second load resistor, a second switching element, a second voltage stabilizing element, a second control resistor and a second control capacitor. A first terminal of the first load resistor may be coupled to a first node. A first terminal of the first switching element may be coupled to a second terminal of the first load resistor. A second terminal of the first switching element may be coupled to a first terminal of the first control resistor at a second node. A control terminal of the first switching element may be coupled to a second terminal of the first control resistor. The first voltage stabilizing element may be coupled to the first node and configured to be turned off in response to a voltage level of the first node being lower than a first critical voltage level, and turned on in response to the voltage level of the first node being higher than or equal to the first critical voltage level. The first control capacitor may be coupled between the first voltage stabilizing element and the control terminal of the first switching element. A first terminal of the second load resistor may be coupled to the first node. A first terminal of the second switching element may be coupled to a second terminal of the second load resistor. A second terminal of the second switching element may be coupled to a first terminal of the second control resistor at the second node. A control terminal of the second switching element may be coupled to a second terminal of the second control resistor. The second voltage stabilizing element may be coupled to the first node and configured to be turned off in response to a voltage level of the first node being lower than a second critical voltage level, and turned on in response to the voltage level of the first node being higher than or equal to the second critical voltage level. The second control capacitor may be coupled between the second voltage stabilizing element and the control terminal of the second switching element. The power supply apparatus may supply the initial voltage to the first node and receive the feedback current signal from the second node. The initial voltage may be higher than or equal to the sum of the first critical voltage level and an enabling voltage level of the first switching element, or the sum of the second critical voltage level and an enabling voltage level of the second switching element.

In some implementations, the first information feature may be a first current level, and the second information feature may be a second current level different from the first current level.

In some implementations, the load apparatus may comprise a microcontroller configured to control a current generator to generate the feedback current signal based on the initial voltage.

In some implementations, the first information feature may be a current level, and the second information feature may be the number of current pulse(s) (at least one) appearing after the current level returns to zero.

In some implementations, the power supply apparatus may comprise a current detection unit and a feedback control unit. The current detection unit may be configured to detect the first information feature and the second information feature. The feedback control unit may be configured to determine the first power supply parameter and the second power supply parameter according to the first information feature, the second information feature and a look-up table, and control a DC conversion unit to supply electric power to the load apparatus based on the first power supply parameter and the second power supply parameter.

Another aspect of the present invention may be related to a load apparatus comprising an input node, a feedback current signal generation module and an output node. The input node may receive an initial voltage. The feedback current signal generation module may be coupled to the input node and configured to generate a feedback current signal transmitted by the output node in response to the initial voltage. The feedback current signal may have at least a first information feature and a second information feature. The feedback current signal generation module may comprise a first circuit module generating the first information feature in response to the initial voltage, and a second circuit module generating the second information feature in response to the initial voltage.

In some implementations, the first circuit module may comprise a load resistor, a switching element and a voltage stabilizing element. A first terminal of the load resistor may be coupled to the input node. A first terminal of the switching element may be coupled to a second terminal of the load resistor. A second terminal of the switching element may be coupled to the output node. The voltage stabilizing element may be coupled to the input node and configured to be turned off in response to a voltage level of the input node being lower than a critical voltage level, and turned on in response to the voltage level of the input node being higher than or equal to the critical voltage level. The second circuit module may comprise a control resistor and a control capacitor. A first terminal of the control resistor may be coupled to the output node, and a second terminal of the control resistor may be coupled to a control terminal of the switching element. The control capacitor may be coupled between the voltage stabilizing element and the control terminal of the switching element. The initial voltage may be larger than or equal to the sum of the critical voltage level and an enabling voltage level of the switching element.

In some implementations, the first information feature may be a current level, and the second information feature may be a time duration before the current level returns to zero.

In some implementations, the first circuit module may comprise a first load resistor, a first switching element, a first voltage stabilizing element, a first control resistor and a first control capacitor. A first terminal of the first load resistor may be coupled to the input node. A first terminal of the first switching element may be coupled to a second terminal of the first load resistor. A second terminal of the first switching element may be coupled to a first terminal of the first control resistor at the output node. A control terminal of the first switching element may be coupled to a second terminal of the first control resistor. The first voltage stabilizing element may be coupled to the input node and configured to be turned off in response to a voltage level of the input node being lower than a first critical voltage level, and turned on in response to the voltage level of the input node being higher than or equal to the first critical voltage level. The first control capacitor may be coupled between the first voltage stabilizing element and the control terminal of the first switching element. The second circuit module may comprise a second load resistor, a second switching element, a second voltage stabilizing element, a second control resistor and a second control capacitor. A first terminal of the second load resistor may be coupled to the input node. A first terminal of the second switching element may be coupled to a second terminal of the second load resistor. A second terminal of the second switching element may be coupled to a first terminal of the second control resistor at the output node. A control terminal of the second switching element may be coupled to a second terminal of the second control resistor. The second voltage stabilizing element may be coupled to the input node and configured to be turned off in response to a voltage level of the input node being lower than a second critical voltage level, and turned on in response to the voltage level of the input node being higher than or equal to the second critical voltage level. The second control capacitor may be coupled between the second voltage stabilizing element and the control terminal of the second switching element. The initial voltage may be higher than or equal to the sum of the first critical voltage level and an enabling voltage level of the first switching element, or the sum of the second critical voltage level and an enabling voltage level of the second switching element.

In some implementations, the first information feature may be a first current level, and the second information feature may be a second current level different from first current level.

In some implementations, the feedback current signal generation module may comprise a microcontroller and a current generator acting as the first circuit module, the second circuit module, or both the first circuit module and the second circuit module, based on the initial voltage.

In some implementations, the first information feature may be a current level, the second information feature may be the number of current pulse(s) (at least one) appearing after the current level returns to zero.

Still another aspect of the present invention may be related to a power supply control method, comprising: supplying an initial voltage to a load apparatus; receiving a feedback current signal from the load apparatus and determining a first power supply parameter and a second power supply parameter according to the feedback current signal, the first power supply parameter may be one selected from voltage, current or wattage of the feedback current signal, and the second power supply parameter may be another one selected from the voltage, the current or the wattage of the feedback current signal different from the first power supply parameter; supplying electric power to the load apparatus based on the first power supply parameter and the second power supply parameter; and detecting a feedback current of the load apparatus to determine whether to supply the initial voltage and determine the first power supply parameter and the second power supply parameter again.

In some implementations, determining the first power supply parameter and the second power supply parameter according to the feedback current signal comprises: determining the first power supply parameter and the second power supply parameter according to a first information feature and a second information feature of the feedback current signal and a look-up table.

In some implementations, determining the first power supply parameter and the second power supply parameter according to the feedback current signal comprises: detecting a current level of the feedback current signal to determine the first power supply parameter, and detecting the time duration before the current level returns to zero to determine the second power supply parameter.

In some implementations, determining the first power supply parameter and the second power supply parameter according to the feedback current signal comprises: detecting a first current level of the feedback current signal to determine the first power supply parameter, and detecting a second current level different from the first current level to determine the second power supply parameter.

In some implementations, determining the first power supply parameter and the second power supply parameter according to the feedback current signal comprises: detecting a current level of the feedback current signal to determine the first power supply parameter, and detecting the number of current pulse(s) (at least one) appearing after the current level returns to zero to determine the second power supply parameter.

### BRIEF DESCRIPTION OF THE DRAWINGS

FIG. 1 is a power supply control system schematic diagram according to the present invention.

FIG. 2A is a load apparatus schematic diagram according to a first embodiment of the present invention.

FIG. 2B is a feedback current signal waveform diagram according to the first embodiment of the present invention.

FIG. 3A is a load apparatus schematic diagram according to a second embodiment of the present invention.

FIG. 3B is a feedback current signal waveform diagram according to the second embodiment of the present invention.

FIG. 4A is a load apparatus schematic diagram according to a third embodiment of the present invention.

FIG. 4B is a feedback current signal waveform diagram according to the third embodiment of the present invention.

FIG. 5 is a power supply control module schematic diagram according to some implementations of the present invention.

FIG. 6A is a power supply control method flowchart according to the present invention.

FIG. 6B is a power supply parameter determination flowchart according to the first embodiment of the present invention.

FIG. 6C is a power supply parameter determination flowchart according to the second embodiment of the present invention.

FIG. 6D is a power supply parameter determination flowchart according to the third embodiment of the present invention.

### DETAILED DESCRIPTION

Features of the present invention are set forth below in connection with the appended drawings, for the purpose of providing a thorough view of various concepts while not intended to represent the only configurations in which the concepts described herein may be practiced. One of ordinary skill in the art may, after understanding embodiments of the present invention, change and modify the techniques taught herein without departing from the spirit and scope of the present invention.

The terms “include”, “comprise”, “have”, “contain”, etc. used herein are open-ended terms that specify the existence of the described features, regions, wholes, steps, operations, elements and/or parts, but do not exclude the existence or addition of one or more other features, regions, wholes, steps, operations, elements, parts and/or their combinations, that is, they mean including but not limited to.

As used herein, unless the content clearly indicates otherwise, the singular forms “a”, “an” and “the” are intended to include plural forms, including “at least one”. The terms “or” and “and/or” used herein includes any or all combinations of the items described.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning consistent with their meaning in the context of the relevant art and the present invention, and will not be interpreted in an idealized or overly formal sense unless expressly so defined herein.

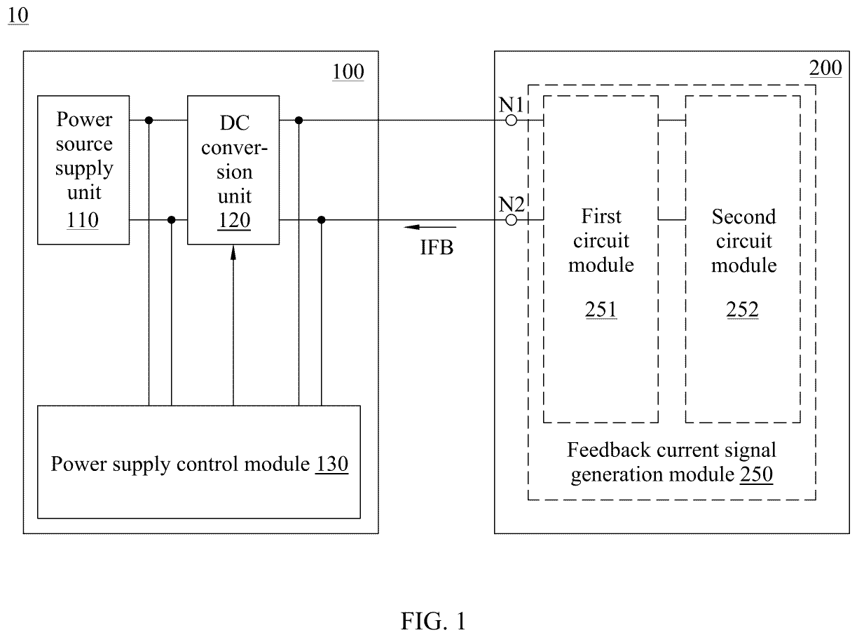

FIG. 1 is a power supply control system schematic diagram according to the present invention. As shown in FIG. 1, the power supply control system 10 may comprise a power supply apparatus 100 and a load apparatus 200. The power supply apparatus 100 may supply an initial voltage to a first node N1, namely, an input node of the load apparatus 200. The load apparatus 200 may receive the initial voltage and transmit a feedback current signal IFB to the power supply apparatus 100 via a second node N2, namely, output node of the power supply apparatus 100, in response to the initial voltage. The feedback current signal IFB may include at least a first information feature and a second information feature. The power supply apparatus 100 may detect the first information feature and the second information feature, determine a first power supply parameter and a second power supply parameter from the first information feature and the second information feature, respectively, and supply electric power to the load apparatus 200 according to the first power supply parameter and the second power supply parameter. The first power supply parameter may be one selected from voltage, current or wattage of the feedback current signal IFB, and the second power supply parameter may be another one of the voltage, the current or the wattage of the feedback current signal IFB different from the first power supply parameter.

As shown in FIG. 1, in some aspects, the power supply apparatus 100 may comprise a power source supply unit 110, a direct current (DC) conversion unit 120 and a power supply control module 130. The power source supply unit 110 may supply operational electric power to the DC conversion unit 120 and the power supply control module 130. The DC conversion unit 120 may supply the initial voltage to the first node N1. The power supply control module 130 may receive the feedback current signal IFB from the second node N2, detect the first information feature and the second information feature, determine the first power supply parameter and the second power supply parameter from the first information feature and the second information feature, respectively, and, in turn, control the DC conversion unit 120 to supply electric power to the first node N1. The power source supply unit 110 may be implemented, for example, as a switched-mode power supply with mains power as input. The DC conversion unit 120 may be implemented, for example, as a DC-DC buck converter. The power supply control module 130 may be implemented, for example, as a microcontroller.

As shown in FIG. 1, the load apparatus 200 may comprise the first node N1, a feedback current signal generation module 250 and the second node N2. Furthermore, the feedback current signal generation module 250 may comprise a first circuit module 251 and a second circuit module 252. In response to the initial voltage received at the first node N1, the first circuit module 251 may generate the first information feature, the second circuit module 252 may generate the second information feature, the first information feature and the second information feature combined may form the feedback current signal IFB, and the feedback current signal IFB may be transmitted at the second node N2. The following embodiments will describe in detail various configurations of the first circuit module 251 and the second circuit module 252, as well as various forms of the feedback current signal IFB.

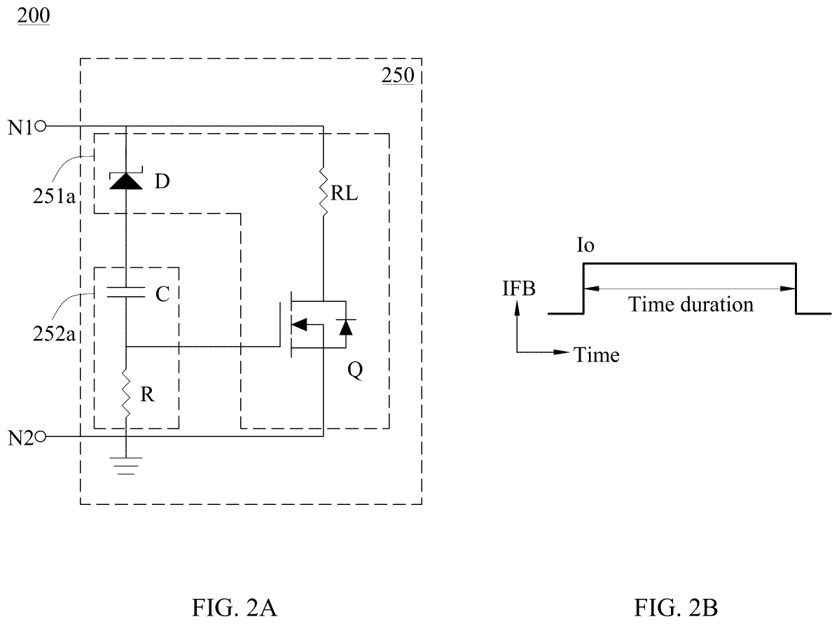

FIG. 2A is a load apparatus schematic diagram according to a first embodiment of the present invention. FIG. 2B is a feedback current signal waveform diagram according to the first embodiment of the present invention. As shown in FIG. 2A, a first circuit module 251a may comprise a load resistor RL, a switching element Q and a voltage stabilizing element D. A first terminal of the load resistor RL may be coupled to the first node N1. A first terminal of the switching element Q may be coupled to a second terminal of the load resistor RL, and a second terminal of the switching element Q may be coupled to the second node N2. The voltage stabilizing element D may be coupled to the first node N1. A second circuit module 252a may comprise a control resistor R and a control capacitor C. A first terminal of the control resistor R may be coupled to the second node N2, and a second terminal of the control resistor R may be coupled to a control terminal of the switching element Q. The control capacitor C may be coupled between the voltage stabilizing element D and the control terminal of the switching element Q. In some aspects, the second node N2 may have a ground voltage level.

The voltage stabilizing element D may be turned on or off according to the voltage level of the first node N1. For example, when the voltage level of the first node N1 is higher than or equal to a critical voltage level of the voltage stabilizing element D, the voltage stabilizing element D may be turned on, and the control capacitor C may adjust the voltage level of the control terminal of the switching element Q according to the voltage level of the first node N1 and control the switching element Q. When the voltage level of the first node N1 is lower than the critical voltage level of the voltage stabilizing element D, the voltage stabilizing element D may be turned off, such that the voltage level of the first node N1 does not affect the voltage level of the control terminal of the switching element Q. In some aspects, the critical voltage level of the voltage stabilizing element D may correspond to an operating voltage level of the load apparatus 200. The voltage stabilizing element D may be implemented, for example, as a Zener diode. In some aspects, the anode of the voltage stabilizing element D may be coupled to the control capacitor C, and the cathode of the voltage stabilizing element D may be coupled to the first node N1.

Referring also to FIG. 2B, upon the power supply apparatus 100 supplying to the first node N1 an initial voltage higher than the critical voltage level of the voltage stabilizing element D, the voltage stabilizing element D may be turned on to charge the control capacitor C. Here, the voltage of the second terminal of the control resistor R may be equal to the initial voltage minus the critical voltage level; preferably, the voltage of the second terminal of the control resistor R may be higher than or equal to the enabling voltage level of the switching element Q, and the initial voltage may be larger than or equal to the sum of the critical voltage level and the enabling voltage level of the switching element Q. From here, the switching element Q may be turned on and output a current level Io. The current level Io may correspond to a value of the initial voltage divided by the resistance value of the load resistor RL and may act as the first information feature of the feedback current signal IFB. In the embodiment described herein, the resistance value of the load resistor RL may determine the magnitude of the current level Io. The power supply apparatus 100 may detect the first information feature via the second node N2 to determine the first power supply parameter. For example, the first power supply parameter may be determined as voltage 20 V according to a current level Io of 20 mA. After the control capacitor C is charged for a time duration, the voltage of the second terminal of the control resistor R may become lower than the enabling voltage level of the switching element Q, the switching element Q may be turned off, and the current level Io may return to zero. The aforesaid time duration may act as the second information feature of the feedback current signal IFB, which is determined by the charging time of the control capacitor C. The power supply apparatus 100 may detect the second information feature via the second node N2, determine the second power supply parameter from the second information feature, such as determining the second power supply parameter to be wattage 110 W according to an Io time duration of 110 ms, and supply the electric power to the load apparatus 200 based on the first power supply parameter and the second power supply parameter.

It is understandable for those skilled in the art that the first power supply parameter can also expressed as current or wattage, whereas the second power supply parameter can also expressed as voltage or current, and the present invention is not limited thereto. The load apparatus 200 according to the first embodiment of the present invention is beneficial due to a simple configuration, where the capacitance value of the control capacitor C and the resistance value of the control resistor R may be required to have an error within 1%, and a 16-bit microcontroller may be required for the corresponding power supply apparatus 100 to meet the time accuracy requirement. Therefore, a higher component cost for the first embodiment makes it suitable for miniaturized network devices such as network cameras, wireless sharing devices, etc.

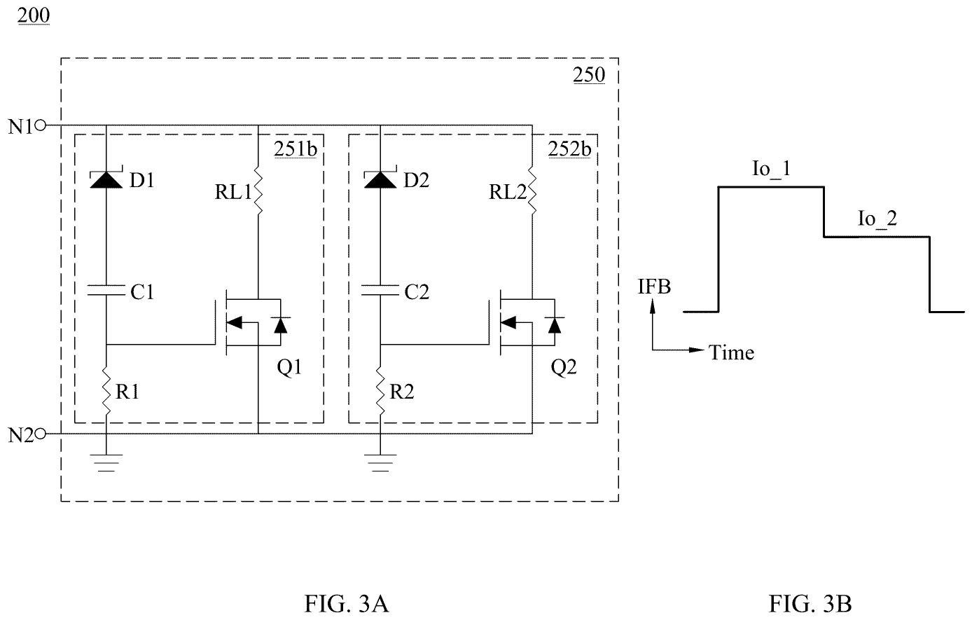

FIG. 3A is a load apparatus schematic diagram according to the second embodiment of the present invention. FIG. 3B is a feedback current signal waveform diagram according to the second embodiment of the present invention. As shown in FIG. 3A, a first circuit module 251b may comprise a first load resistor RL1, a first switching element Q1, a first voltage stabilizing element D1, a first control resistor R1 and a first control capacitor C1. A first terminal of the first load resistor RL1 may be coupled to the first node N1. A first terminal of the first switching element Q1 may be coupled to a second terminal of the first load resistor RL1. A second terminal of the first switching element Q1 may be coupled to a first terminal of the first control resistor R1 at the second node N2. A control terminal of the first switching element Q1 may be coupled to a second terminal of the first control resistor R1. The first voltage stabilizing element D1 may be coupled to the first node N1. The first control capacitor C1 may be coupled between the first voltage stabilizing element D1 and the control terminal of the first switching element Q1. A second circuit module 252b may comprise a second load resistor RL2, a second switching element Q2, a second voltage stabilizing element D2, a second control resistor R2 and a second control capacitor C2. A first terminal of the second load resistor RL2 may be coupled to the first node N1. A first terminal of the second switching element Q2 may be coupled to a second terminal of the second load resistor RL2. A second terminal of the second switching element Q2 may be coupled to a first terminal of the second control resistor R2 at the second node. A control terminal of the second switching element Q2 may be coupled to a second terminal of the second control resistor R2. The second voltage stabilizing element D2 may be coupled to the first node N1. The second control capacitor C2 may be coupled between the second voltage stabilizing element D2 and the control terminal of the second switching element Q2.

In some aspects, the second node N2 may have a ground voltage level. Similar to the aforesaid first embodiment, the first voltage stabilizing element D1 and the second voltage stabilizing element D2 may be turned on or off according to the voltage level of the first node N1.

Referring also to FIG. 3B, upon the power supply apparatus 100 supplying to the first node N1 an initial voltage higher than the first critical voltage level of the first voltage stabilizing element D1 and the second critical voltage level of the second voltage stabilizing element D2, the first voltage stabilizing element D1 and the second voltage stabilizing element D2 may be turned on to charge the first control capacitor C1 and the second control capacitor C2, respectively. Here, the voltage of the second terminal of the first control resistor R1 may equal to the initial voltage minus the first critical voltage level; and the second terminal of the second control resistor R2 may equal to the initial voltage minus the second critical voltage level. Further, the voltage of the second terminal of the first control resistor R1 may be higher than or equal to the enabling voltage level of the first switching element Q1; the voltage of the second terminal of the second control resistor R2 may be higher than or equal to the enabling voltage level of the second switching element Q2, and the initial voltage may be a larger one of the sum of the critical voltage level and the enabling voltage level of the first switching element Q1 and the sum of the critical voltage level and the enabling voltage level of the second switching element Q2. From here, the first switching element Q1 and the second switching element Q2 may be turned on, and a current level Io_1 at the second node N2 may be equal to a sum of the initial voltage divided by the resistance value of the first load resistor RL1 and the initial voltage divided by the resistance value of the second load resistor RL2. The current level Io_1 may then act as the first information feature of the feedback current signal IFB. The power supply apparatus 100 may detect the first information feature via the second node N2 to determine the first power supply parameter. For example, the first power supply parameter may be determined as voltage 20 V according to a current level Io_1 of 20 mA. After the first control capacitor C1 is charged for a time duration, the voltage of the second terminal of the first control resistor R1 may become lower than the enabling voltage level of the first switching element Q1, the voltage of the second terminal of the second control resistor R2 may still be higher than or equal to the enabling voltage level of the second switching element Q2. Then, the first switching element Q1 may be turned off while the second switching element Q2 remains on. Therefore, a current level Io_2 of the second node N2 may equal the initial voltage divided by the resistance value of the second load resistor RL2 to act as the second information feature of the feedback current signal IFB. The power supply apparatus 100 may detect the second information feature via the second node N2 to determine the second power supply parameter, such as determining the second power supply parameter to be wattage 110 W according to a current level Io_2 of 11 mA, and supply the electric power to the load apparatus 200 based on the first power supply parameter and the second power supply parameter.

It is understandable for those skilled in the art that the first power supply parameter can also expressed as current or wattage, whereas the second power supply parameter can also expressed as voltage or current, and the present invention is not limited thereto. The more complex configuration of the load apparatus 200 according to the second embodiment of the present invention makes error requirements of the control capacitors and the control resistors less high. For example, general-grade control capacitors and control resistors may be utilized, and an 8-bit microcontroller can be used for the corresponding power supply apparatus 100. Therefore, the second embodiment of the present invention has the effect of lower component cost and is generally suitable for equipment deployed in large quantities, such as emergency signal systems.

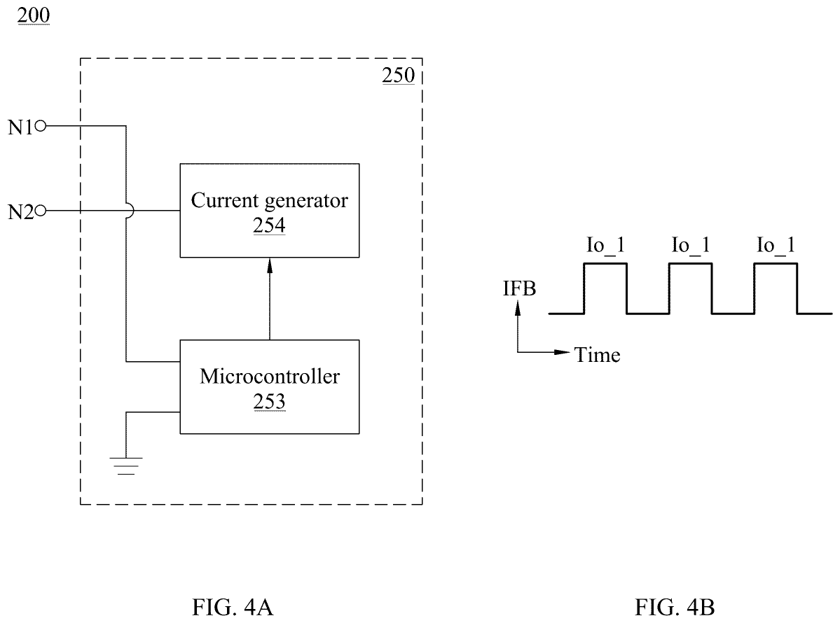

FIG. 4A is a load apparatus schematic diagram according to the third embodiment of the present invention. FIG. 4B is a feedback current signal waveform diagram according to the third embodiment of the present invention. As shown in FIG. 4A, a feedback current signal generation module 250 may comprise a microcontroller 253 and a current generator 254. Referring also to FIG. 4B, upon the power supply apparatus 100 supplying to the first node N1 an initial voltage, the microcontroller 253 may control the current generator 254 to output a current level Io_1 for a certain time duration. That is, the current level Io_1 may act as the first information feature of the feedback current signal IFB, and the outputting of the current level Io_1 for a certain time duration may be equivalent to configuration of the aforesaid first circuit module. The power supply apparatus 100 may detect the first information feature via the second node N2 to determine the first power supply parameter. For example, the first power supply parameter may be determined as voltage 20 V according to a current level Io_1 of 20 mA. After the current level Io_1 returns to zero, the microcontroller 253 may control the current generator 254 to output at least one current pulse. The number of current pulse(s) may act as the second information feature of the feedback current signal IFB, and the outputting of the at least one current pulse may be equivalent to configuration of the aforesaid second circuit module. The power supply apparatus 100 may detect the second information feature via the second node N2 to determine the second power supply parameter. For example, assume that each current pulse represents a wattage of 50 W, then the second power supply parameter may be determined as wattage 150 W according to the current level Io_1 and two current pulses thereafter, namely, three current pulses in total. Then, the power supply apparatus 100 may supply the electric power to the load apparatus 200 based on the first power supply parameter and the second power supply parameter.

It is understandable for those skilled in the art that the first power supply parameter may also express as current or wattage, the second power supply parameter can also express voltage or current, and the present invention is not limited thereto. The load apparatus 200 according to the third embodiment of the present invention may have a strong anti-interference effect and is therefore suitable for equipment with long transmission distances, such as wireless base stations, outdoor electronic billboards, etc.

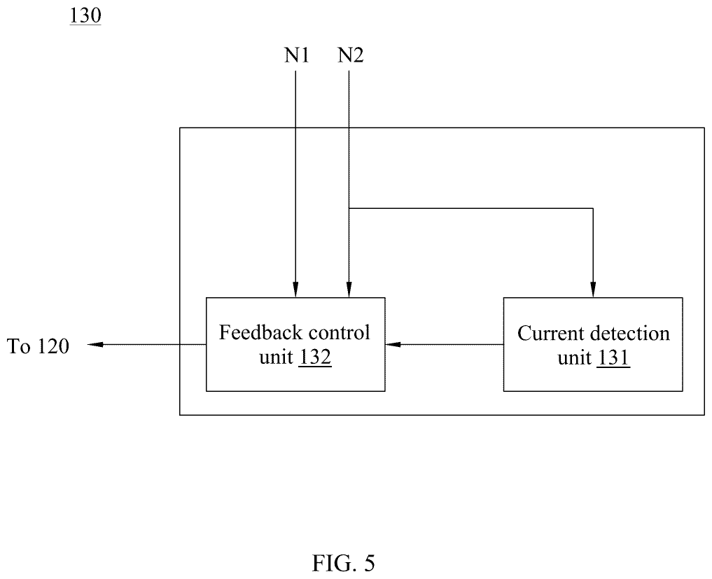

FIG. 5 is a power supply control module schematic diagram according to some implementations of the present invention. As shown in FIG. 5, the power supply control module 130 may comprise a current detection unit 131 and a feedback control unit 132. The current detection unit 131 may detect the first information feature and the second information feature of the feedback current signal IFB. The feedback control unit 132 may determine the first power supply parameter and the second power supply parameter according to the first information feature, the second information feature, a look-up table, etc., in order to control the DC conversion unit 120 to supply electric power to the load apparatus 200. In some aspects, during supply of the electric power to the load apparatus 200 based on the first power supply parameter and the second power supply parameter, the power supply control module 130 may continuously detect a feedback current of the load apparatus 200. If the feedback current is detected as abnormal, the DC conversion unit 120 may be controlled to supply the initial voltage in order to detect whether the load apparatus 200 is connected normally, and/or the power supply parameters should be altered.

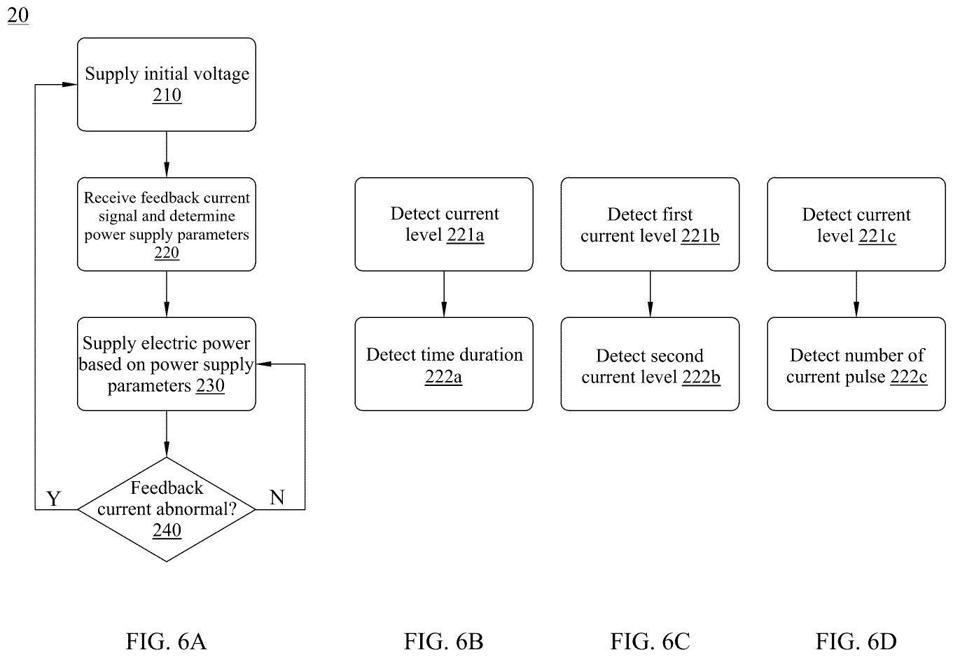

FIG. 6A is a power supply control method flowchart according to the present invention. As shown in FIG. 6A, a power supply control method 20 may comprise: supplying an initial voltage to a load apparatus (step 210); receiving a feedback current signal from the load apparatus and determining a first power supply parameter and a second power supply parameter (step 220), wherein the first power supply parameter may be one selected from voltage, current or wattage of the feedback current signal, and the second power supply parameter may be another one selected from the voltage, the current or the wattage of the feedback current signal different from the first power supply parameter; supplying the electric power to the load apparatus based on the first power supply parameter and the second power supply parameter (step 230); and detecting a feedback current of the load apparatus to determine whether to supply the initial voltage and determine the first power supply parameter and the second power supply parameter again (step 240). In some implementations, the first power supply parameter and the second power supply parameter may be determined according to a first information feature and a second information feature of the feedback current signal and a look-up table.

As shown in FIG. 6B, according to the first embodiment of the present invention, determining the first power supply parameter and the second power supply parameter (step 220) may comprise: detecting a current level (i.e., first information feature) of the feedback current signal to determine the first power supply parameter (step 221a), and detecting a time duration before the current level returns to zero (i.e., second information feature) to determine the second power supply parameter (step 222a).

As shown in FIG. 6C, according to the second embodiment of the present invention, determining the first power supply parameter and the second power supply parameter (step 220) may comprise: detecting a first current level (i.e., first information feature) of the feedback current signal to determine the first power supply parameter (step 221b), and detecting a second current level (i.e., second information feature) different from first current level to determine the second power supply parameter (step 222b).

As shown in FIG. 6D, according to the third embodiment of the present invention, determining the first power supply parameter and the second power supply parameter (step 220) may comprise: detecting a current level (i.e., first information feature) of the feedback current signal to determine the first power supply parameter (step 221c), and detecting the number (i.e., second information feature) of at least one current pulse(s) appearing after the current level returns to zero to determine the second power supply parameter (step 222c).

Although the present invention has been disclosed as above by the embodiments, it is not intended to limit the present invention. One of ordinary skill in the art can make various changes and modifications without departing from the spirit and scope of the present invention. Accordingly, the scope of the present invention is to be accorded the broadest scope consistent with the appended claims rather than the foregoing description and the exemplary embodiments described therein.

What is claimed is:

1. A power supply control system, comprising:
a power supply apparatus configured to supply an initial voltage; and
a load apparatus configured to receive the initial voltage and transmit a feedback current signal to the power supply apparatus in response to the initial voltage, wherein the feedback current signal having at least a first information feature and a second information feature;
wherein the power supply apparatus is configured to:
detect the first information feature to determine a first power supply parameter;
detect the second information feature to determine a second power supply parameter; and
supply electric power to the load apparatus based on the first power supply parameter and the second power supply parameter,
wherein the first power supply parameter is one selected from voltage, current or wattage of the feedback current signal, and the second power supply parameter is another one selected from the voltage, the current or wattage of the feedback current signal different from the first power supply parameter.

2. The power supply control system of claim 1, wherein the load apparatus comprises:
a load resistor, wherein a first terminal of the load resistor is coupled to a first node;
a switching element, wherein a first terminal of the switching element is coupled to a second terminal of the load resistor, a second terminal of the switching element is coupled to a first terminal of a control resistor at a second node, and a control terminal of the switching element is coupled to a second terminal of the control resistor;
a voltage stabilizing element, coupled to the first node and configured to be turned off in response to a voltage level of the first node being lower than a critical voltage level, and be turned on in response to the voltage level of the first node being higher than or equal to the critical voltage level; and
a control capacitor coupled between the voltage stabilizing element and the control terminal of the switching element,
wherein the power supply apparatus supplies the initial voltage to the first node and receives the feedback current signal from the second node, and
wherein the initial voltage is higher than or equal to a sum of the critical voltage level and an enabling voltage level of the switching element.

3. The power supply control system of claim 2, wherein the first information feature is a current level, and the second information feature is a time duration before the current level returns to zero.

4. The power supply control system of claim 1, wherein the load apparatus comprises:
a first load resistor, wherein a first terminal of the first load resistor is coupled to a first node;
a first switching element, wherein a first terminal of the first switching element is coupled to a second terminal of the first load resistor, a second terminal of the first switching element is coupled to a first terminal of a first control resistor at a second node, a control terminal of the first switching element is coupled to a second terminal of the first control resistor;
a first voltage stabilizing element, coupled to the first node and configured to be turned off in response to a voltage level of the first node being lower than a first critical voltage level, and be turned on in response to the voltage level of the first node being higher than or equal to the first critical voltage level;
a first control capacitor coupled between the first voltage stabilizing element and the control terminal of the first switching element;
a second load resistor, wherein a first terminal of the second load resistor is coupled to the first node;
a second switching element, wherein a first terminal of the second switching element is coupled to a second terminal of the second load resistor, a second terminal of the second switching element is coupled to a first terminal of a second control resistor at the second node, and a control terminal of the second switching element is coupled to a second terminal of the second control resistor;
a second voltage stabilizing element, coupled to the first node and configured to be turned off in response to the voltage level of the first node being lower than a second critical voltage level, and be turned on in response to the voltage level of the first node being higher than or equal to the second critical voltage level; and
a second control capacitor coupled between the second voltage stabilizing element and the control terminal of the second switching element,
wherein the power supply apparatus supplies the initial voltage to the first node and receives the feedback current signal from the second node, and
wherein the initial voltage is higher than or equal to a sum of the first critical voltage level and an enabling voltage level of the first switching element, or a sum of the second critical voltage level and an enabling voltage level of the second switching element.

5. The power supply control system of claim 4, wherein the first information feature is a first current level, and the second information feature is a second current level different from the first current level.

6. The power supply control system of claim 1, wherein the load apparatus comprises a microcontroller, configured to control a current generator to generate the feedback current signal based on the initial voltage.

7. The power supply control system of claim 6, wherein the first information feature is a current level, and the second information feature is a number of at least one current pulse appearing after the current level returns to zero.

8. The power supply control system of claim 1, wherein the power supply apparatus comprises:
a current detection unit, configured to detect the first information feature and the second information feature; and
a feedback control unit, configured to determine the first power supply parameter and the second power supply parameter according to the first information feature, the second information feature and a look-up table, and control a DC conversion unit to supply the electric power to the load apparatus according to the first power supply parameter and the second power supply parameter.

9. A load apparatus, comprising:
an input node configured to receive an initial voltage;
a feedback current signal generation module coupled to the input node and configured to generate a feedback current signal in response to the initial voltage, wherein the feedback current signal has at least a first information feature and a second information feature;
wherein the feedback current signal generation module comprises:
a first circuit module configured to generate the first information feature in response to the initial voltage; and
a second circuit module configured to generate the second information feature in response to the initial voltage; and
an output node configured to transmit the feedback current signal.

10. The load apparatus of claim 9, wherein:
the first circuit module comprises:
a load resistor, wherein a first terminal of the load resistor is coupled to the input node;
a switching element, wherein a first terminal of the switching element is coupled to a second terminal of the load resistor, and a second terminal of the switching element is coupled to the output node; and
a voltage stabilizing element, coupled to the input node, and configured to be turned off in response to a voltage level of the input node being lower than a critical voltage level, and be turned on in response to the voltage level of the input node being higher than or equal to the critical voltage level; and
the second circuit module comprises:
a control resistor, wherein a first terminal of the control resistor is coupled to the output node, and a second terminal of the control resistor is coupled to a control terminal of the switching element; and
a control capacitor coupled between the voltage stabilizing element and the control terminal of the switching element,
wherein the initial voltage is higher than or equal to a sum of the critical voltage level and an enabling voltage level of the switching element.

11. The load apparatus of claim 10, wherein the first information feature is a current level, and the second information feature is a time duration before the current level returns to zero.

12. The load apparatus of claim 9, wherein:
the first circuit module comprises:
a first load resistor, wherein a first terminal of the first load resistor is coupled to the input node;
a first switching element, wherein a first terminal of the first switching element is coupled to a second terminal of the first load resistor, a second terminal of the first switching element is coupled to a first terminal of a first control resistor at the output node, and a control terminal of the first switching element is coupled to a second terminal of the first control resistor;
a first voltage stabilizing element, coupled to the input node, and configured to be turned off in response to a voltage level of the input node being lower than a first critical voltage level, and be turned on in response to the voltage level of the input node being higher than or equal to the first critical voltage level; and
a first control capacitor coupled between the first voltage stabilizing element and the control terminal of the first switching element; and
the second circuit module comprises:
a second load resistor, wherein a first terminal of the second load resistor is coupled to the input node;
a second switching element, wherein a first terminal of the second switching element is coupled to a second terminal of the second load resistor, a second terminal of the second switching element is coupled to a first terminal of a second control resistor at the output node, and a control terminal of the second switching element is coupled to a second terminal of the second control resistor;
a second voltage stabilizing element, coupled to the input node, and configured to be turned off in response to the voltage level of the input node being lower than a second critical voltage level, and be turned on in response to the voltage level of the input node being higher than or equal to the second critical voltage level; and
a second control capacitor coupled between the second voltage stabilizing element and the control terminal of the second switching element,
wherein the initial voltage is higher than or equal to a sum of the first critical voltage level and an enabling voltage level of the first switching element, or a sum of the second critical voltage level and an enabling voltage level of the second switching element.

13. The load apparatus of claim 12, wherein the first information feature is a first current level, and the second information feature is a second current level different from the first current level.

14. The load apparatus of claim 9, wherein the feedback current signal generation module comprises a microcontroller and a current generator to act as the first circuit module, the second circuit module, or both the first circuit module and the second circuit module based on the initial voltage.

15. The load apparatus of claim 14, wherein the first information feature is a current level, and the second information feature is a number of at least one current pulse appearing after the current level returns to zero.

16. A power supply control method, comprising:
supplying an initial voltage to a load apparatus;
receiving a feedback current signal from the load apparatus and determining a first power supply parameter and a second power supply parameter based on the feedback current signal, wherein the first power supply parameter is one selected from voltage, current or wattage of the feedback current signal, and the second power supply parameter is another one selected from the voltage, the current or wattage of the feedback current signal different from the first power supply parameter;
supplying electric power to the load apparatus based on the first power supply parameter and the second power supply parameter; and
detecting a feedback current of the load apparatus to determine whether to supply the initial voltage and determine the first power supply parameter and the second power supply parameter again.

17. The power supply control method of claim 16, wherein determining the first power supply parameter and the second power supply parameter based on the feedback current signal comprises: determining the first power supply parameter and the second power supply parameter according to a first information feature and a second information feature of the feedback current signal and a look-up table.

18. The power supply control method of claim 16, wherein determining the first power supply parameter and the second power supply parameter based on the feedback current signal comprises: detecting a current level of the feedback current signal to determine the first power supply parameter, and detecting a time duration before the current level returns to zero to determine the second power supply parameter.

19. The power supply control method of claim 16, wherein determining the first power supply parameter and the second power supply parameter based on the feedback current signal comprises: detecting a first current level of the feedback current signal to determine the first power supply parameter, and detecting a second current level different from the first current level to determine the second power supply parameter.

20. The power supply control method of claim 16, wherein determining the first power supply parameter and the second power supply parameter based on the feedback current signal comprises: detecting a current level of the feedback current signal to determine the first power supply parameter, and detecting a number of at least one current pulse appearing after the current level returns to zero to determine the second power supply parameter.
